(19) United States
(12) Patent Application Publication
(10) Pub. No.: US 2026/0030739 A1
(43) Pub. Date: Jan. 29, 2026

(54) IMAGE-BASED MANUFACTURING DEFECT DETECTION

(71) Applicant: MELLANOX TECHNOLOGIES, LTD., Yokneam (IL)

(72) Inventors: Dotan David Levi, Kiryat Motzkin (IL); Yechiel Wiesel, Tel Aviv (IL); Wojciech Wawrzyniec Wasko, Mlynek (PL); Natan Manevich, Migdal HaEmek (IL); Elad Mentovich, Tel Aviv (IL)

(21) Appl. No.: 18/787,530

(22) Filed: Jul. 29, 2024

(51) Int. Cl. G06T 7/00; G06T 1/20; G06V 10/44

(52) U.S. Cl. CPC G06T 7/0008; G06T 1/20; G06V 10/44; G06T 2207/30164

(57) ABSTRACT

Systems and methods herein are for image-based defect detection for items moving through a manufacturing area. A data processing unit (DPU) is in communication with multiple graphics processing units (GPUs) and can receive images captured of an item, as well as receive an indication of image sections of the images associated with a characteristic of a manufacturing process of the item. The DPU can provide the image sections to the GPUs for image processing to determine a value associated with the characteristic of the manufacturing process of the item. The provision of the image sections may be based at least in part on the individual ones of the GPUs being associated with a feature of the item, and the GPUs can perform different image processing based at least in part on different features of the items.

### TECHNICAL FIELD

At least one embodiment pertains to image processing for manufacturing lines.

### BACKGROUND

Image processing may be used in manufacturing lines to provide information about possible defects or to ensure that items under manufacture are free of defects. In one example, detecting defects by imaging may be performed in high-speed manufacturing lines for quality control. The detection may progress using cameras and image processing to identify defects as the items under manufacture move on a conveyor belt or other movement systems. The imaging may be performed using line scan cameras which may capture images of items as they pass through. The images may be captured one at a time. In one example, the images may be from different angles and may be stitched together to form a complete view for further backend image processing. In a further example, standard high-resolution cameras may be used for capturing high-resolution images. All such images may be subject to image processing to support the determination of potential defects in an item. The image processing may include the use of computer vision algorithms to analyze the images. The algorithms may be trained to identify patterns or deviations to indicate a possible defect in an item. The ability to perform such defect monitoring may be reliant on the high-speed ability of the imaging aspect of such a system.

### BRIEF DESCRIPTION OF DRAWINGS

FIG. 1 is an illustration of a system for manufacturing defect detection using only image sections provided to individual one of different GPUs adapted for different image processing, in at least one embodiment;

FIG. 2 is an illustration of aspects of individual ones of different GPUs adapted for different image processing based in part on different features of items under manufacture or different types of defects, in at least one embodiment;

FIG. 3 is an illustration of further aspects of different image processing for items under manufacture or for different types of defects, in at least one embodiment;

FIG. 4 illustrates computer and processor aspects of a system for manufacturing defect detection using only image sections provided to individual ones of different GPUs adapted for different image processing, in at least one embodiment;

FIG. 5 illustrates a process flow for a system for manufacturing defect detection using only image sections provided to individual ones of different GPUs adapted for different image processing, in at least one embodiment;

FIG. 6 illustrates yet another process flow for a system for manufacturing defect detection using only image sections provided to individual ones of different GPUs adapted for different image processing; and

FIG. 7 illustrates a further process flow for a system for manufacturing defect detection using only image sections provided to individual ones of different GPUs adapted for different image processing, in at least one embodiment.

### DETAILED DESCRIPTION

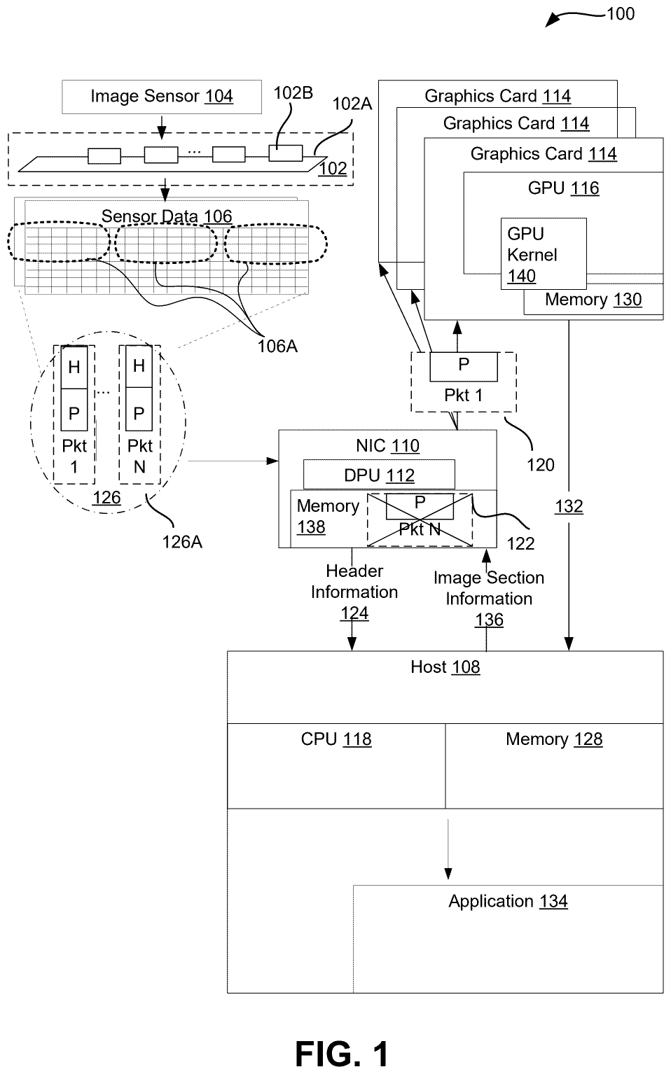

FIG. 1 is an illustration of a system 100 for manufacturing defect detection using only image sections provided to individual ones of different GPUs adapted for different image processing, in at least one embodiment. The system, and a supporting method herein, is for image-based defect detection for items moving through a manufacturing area. A data processing unit (DPU) 112 is in communication with multiple graphics processing units (GPUs) 116 and can receive images captured of an item 102B, as well as receive an indication 136 of image sections 106A of the images (such as, sensor data 106) associated with a characteristic of a manufacturing process of the item. The DPU 112 can provide the image sections 106A (as payload 120) to the GPUs 116 for image processing to determine a value associated with the characteristic of the manufacturing process of the item. The provision of the image sections may be based at least in part on the individual ones of the GPUs 116 being associated with a feature of the item, and the GPUs may be configured to perform different image processing based at least in part on different features of the items.

The system 100 may be adapted for high resolution and high frame-rate cameras that may be deployed, through an image sensor 104, in different locations of a manufacturing area 102. Although described in the singular, as used herein, the image sensor 104 is a collection of multiple cameras. These cameras may be enabled to provide images having sensor data 106 and that pertain to images of items 102B on a manufacturing line 102A. These images may be from the different locations of the manufacturing area 102 and, therefore, may be directed to the items 102B from different angle of the manufacturing area 102. Further, the different angles may allow for different focus of different features of the items 102B.

The cameras may be co-located or located nearby with respect to each other but may also have different exposure characteristics. The system 100 herein may include a host 108 having a host processor or a central processing unit (CPU) 118 that may be associated with a network interface card (NIC) 110 having a data processing unit (DPU) 112 to perform acquisition of the sensor data 106 from the camera(s) and to support detection of defects associated with at least one of the items 102B. The CPU 118 and the DPU 112 may be represented as a compute unit herein. The system 100 herein is able to identify defects with reduced latency, which may otherwise be a limiting factor in infrastructures' manufacturing capabilities.

In one example, when detection for defects is performed for a manufacturing line 102A, the faster the detection occurs and the more support the detection may have for higher manufacturing throughput and better manufacturing yield. The manufacturing yield may be in reference to a percentage of non-defective items 102B passing through the manufacturing line 102A within a predetermined period. Further, when the detection for defects is performed after the manufacturing line 102A, the faster the detection occurs, the more support the detection may have for higher component testing or test time.

The system 100 herein is able to work with both approaches, where detection for defects may be performed at the manufacturing line 102A or just after the manufacturing line 102A. Pertinently, the system 100 can support detection for defects in items 102B that move through the manufacturing line 102A at a predetermined rate, which is also associated with a rate at which the detection for defects may occur. For example, the system 100 can support the determination of the value associated with the characteristic as part of the detection of defects in support of the predetermined rate of movement of the items through the manufacturing line. This may be so that there is no delays or bottlenecks to determining defects that may sometimes be caused by aspects of a manufacturing line and that may result in immediate fixes to the manufacturing line, for instance. In one example, the predetermined rate for the movement through the manufacturing line may be adjustable or may be a threshold difference with respect to a rate at which the detection for defects can occur using the compute and processing nodes herein.

In at least one embodiment, the sensor data 106 may be represented as raw video frames 126 of packets Pkt 1-N 126A. Then, image processing for detection of defects may be performed in the manufacturing line 102A and between machines of the manufacturing line 102A using payload P that is within at least one of the packets Pkt 1-N 126A. In at least one embodiment, however, the image processing is only to occur for image sections 106A that may be removed from the packets Pkt 1-N 126A forming the sensor data 106.

The image sections 106A may be future streamed as part of the raw video frames 126 to an appropriate one of the graphics processing units (GPUs) 116 of a graphics card 114. The GPU or the graphics card may be represented as a processing node herein. Further, each graphics card 114 may include more than one GPU, although one GPU is presently illustrated. Still further, each of the GPUs 116 may be part of a singular card with a DPU 112. This may be an accelerator card or a converged card. Therefore, there may be multiple such singular cards providing at least different one of the GPUs having different capabilities to process different image sections. In one example, the raw video frames 126 may be provided as frames of packets Pkt 1-N 126A, with each packet having a payload and a header. The image sections 106A may be represented as payload P 120 of one or more of the packets, which is illustrated as only from one packet, for illustrative purposes only. The payload P 120 may be from multiple packets hat are provided to an appropriate one of the GPUs 116 of a graphics card based in part on a potential defect or a view for at least one of the items 102B. For example, the appropriate one of the GPUs 116 may have image processing capability to identify, confirm, or provide information associated with the potential defect or the view, where the identify, confirmation, or information may be a confirmation of a defect.

In at least one embodiment, it may be required to time synchronize the compute units and the processing nodes with the image sensor 104 and, possibly, with the manufacturing line 102A. This may be so that streaming fusion may be performed for the images captured and to enable the detection of defects for the items to occur expeditiously. In addition, such synchronization also assists with the predetermined rate for the movement through the manufacturing line, the rate at which the detection for defects can occur using the compute and processing nodes herein, and any threshold difference between the two rates. In at least one embodiment, the system 100 herein may support dimensions of a manufacturing area 102 that vary from few square meters to hundreds of meters in big manufacturing hall. In at least one embodiment, the image sensor 104 may also be time synchronized with one or more of the DPU 112 or the GPUs 116 to enable capture of the images and the image processing in support of the predetermined rate established for the movement of the items 102B through the manufacturing area 102.

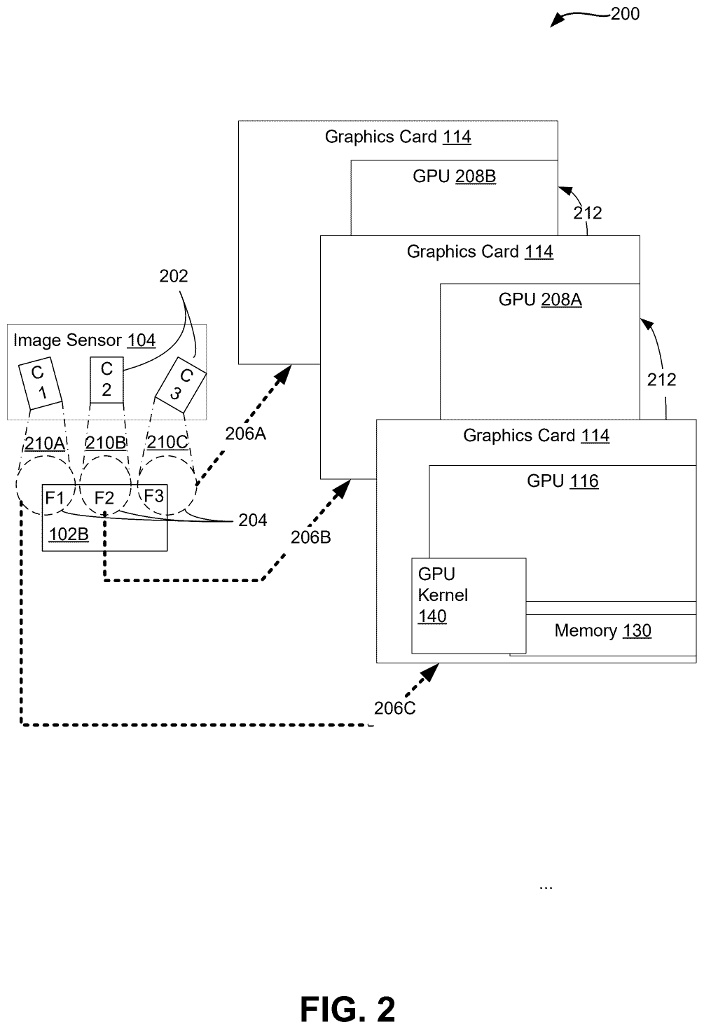

Further, the system 100 includes direct transfer of image processing or sensor data 106, to an appropriate one of the GPUs 116, absent intervention for processing requirements by a CPU 118 of a host 108, also referred to herein as a host machine. For example, an application 134 performed by the CPU 118 may be aware of the contents of the frames of packets Pkt 1-N 126A in the raw video frames 126. In one example, the application 134 may know or have predetermined information of a layout of cameras (such as, C1-C3 in FIG. 2) and may know or have predetermined information about which image section of its field of view captures which portion of an item. The application may also receive 132 information about positive identification of a defect from one or more of the GPUs 116.

In at least one embodiment, the application 134 may be aware of the contents of an image based in part on predetermined information provided to the application 134 for each item 102B. However, header information from the packets 1-N 126A that may be provided for the CPU 118 from the DPU 112 may be also used. The application 134 may indicate, to the DPU 112, the image sections that are associated with a characteristic of a manufacturing process of the item 102B. For example, the characteristic may be a potential defect or a view for at least one of the items. This indication is also referred to here, or may be provided as, the image section information 136 and may be used by the DPU 112 to guide the image sections to an appropriate ones of the GPUs 116, and the appropriate ones of the GPUs 116 can perform its image processing on received payload representing the image sections 106A of the images in the sensor data 106.

In one example, image processing may be to determine a value associated with the characteristic of the manufacturing process of the item. In one example, the characteristic may be a potential defect or view for the item, while the value associated with the characteristic may be based in part on a defect or a type of defect from the potential defect or a view for at least one of the items. Further, the header information 124 may be associated with a Real-Time Transport Protocol (RTP) headers H of the packets Pkt 1-N 126A. For example, when the characteristic is a view of known issue areas or irregularity (such as, scratches, irregularities, uneven surfaces, or mechanical defects), then value associated with a correlation of the extent of the characteristic. For example, the value may reflect the extent of correlation of a defect or a type of defect for the known issue areas or irregularity for the item. The value may be from a predefined pool or range of the known issue areas or irregularity. Then, it is possible to determine the value for the characteristic by an inference, in one example.

In at least one embodiment, each of the GPUs 116 may be adapted to perform specific image processing for only image sections 106A of the images represented by the sensor data 106. Therefore, entire images represented by the sensor data 106 may be received in the DPU 112 but need not be provided from the DPU 112 to any one of the GPUs 116. Further, the provision of only image sections 106A may be performed between the DPU 112 and respective ones of the different GPUs 116. Further, the image sections subject to image processing may be in the format of payload P 120 to the appropriate one of the GPUs 116. In another example, the specific or different image processing to be performed by the different GPUs in the system 100 may be based in part on different features of the items 102B associated with different views of the items 102B, or may be based in part on different types of defects that may be associated with potential defects in the items 102B.

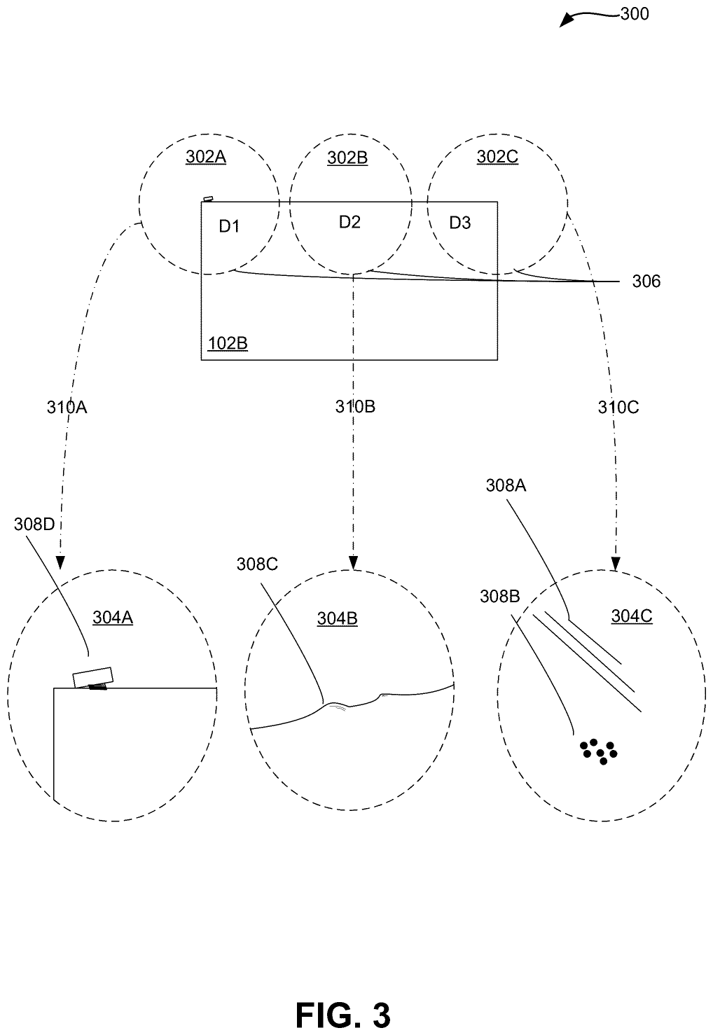

In one example, the different features of the items 102B may be correlated to different potential defects or from different views captured by the cameras of the image sensor 104. Further, for illustrative purposes, the different potential defects or views may be represented by the different image sections 106A that may be sent to different ones of the GPUs 116 for different image processing herein, which is detailed in at least FIG. 3. In another example, the different types of defects may be specific to certain types of items 102B. For example, for semiconductor wafers, the manufacturing process may cause scratches, irregularities, uneven surfaces, or mechanical defects, which may represent different types of defects and may require different types of image processing to be detected.

Therefore, it is possible to determine a value associated with a characteristic of the manufacturing process of the item, where the characteristics may be potential defect or view for the item. The characteristic may include what may be caused during the manufacturing process, including scratches, irregularities, uneven surfaces, or mechanical defects. A characteristic may be measured, determined, or represented by a value. In one example, the value may be a scaled or normalized value. In another example, the value may be correlated, represented, or inferred from a range of values for a defect or type of defects that may be associated with the potential defect or view for the item. This information may be used to confirm a defect for the potential defect or view, in one example. Further, a movement at a predetermined rate for the items of a manufacturing line may be in support of the determination of the value associated with the characteristic.

For other manufactured items, such as a mechanical products, defects may occur at attachment features, such as, in screws, in joints, in bolts, and in other fixtures; and so, the defects may pertain to such features to be detected by the system 100 as being proper or improper. In one example, therefore, the different image processing by the different GPUs 116, in the system 100 herein, must encompasses all such possible defects and may include one or more of pattern recognition, object recognition, feature extraction, feature characterization, or image segmentation to enable a broad spectrum of defects to be detected.

The approaches herein, therefore, enable bypassing of bottlenecks that may otherwise require a CPU 118 to intervene in many aspects of the image processing. For example, the CPU 118 may otherwise be required to receive a raw video frames 126 and may be required to copy entire images represented in the sensor data 106, from a local memory 128 to a memory area 130 of an individual GPU. Furthermore, the individual GPU may have to work through entire images to perform different processes. The approaches herein may, therefore, include at least the DPU 112 that receives information from an application 134 performed by a CPU 118 regarding only image sections to be processed and that need not receive further intervention from the CPU 118. The DPU 112 can provide select payload P of select packets (such as, of Pkt 1 120), corresponding to image sections 106A, to a select ones of the different GPUs 116 for the image processing. Such approaches accelerate defect detection and analysis in the system 100.

Further, the system 100 can operate in a multi-threaded environment and can efficiently manage still or partial images. The system 100 is able to handle multiple raw video frames 126 in concurrent streams from different cameras of the image sensor 106. In one example, the image sections 106 may be coupled directly or indirectly to a DPU 112 of a NIC 110 to pass concurrent streams thereto and the DPU 112 is able to determine the packets of payload P 120 to provide underlying payload to different GPUs 116, while also discarding other packets. In an illustrative example, one or more packets marked Pkt N 122, for a payload P, may be temporarily in a buffer memory 138 associated with the DPU 112 and may be outside those image sections 106A that are to be provided to the different GPUs 116. Therefore, the one or more packets marked Pkt N 122, for the payload P, may be discarded. Further, communication of the image sections 106 to the DPU 112 may be through Ethernet. Whereas communication between the compute units and the processing nodes may be possible through a peripheral component interconnect express (PCIe) standard interconnect or bus between these components.

In at least one embodiment, a singular card having a DPU 112 and multiple GPUs 116 may be configured to be self-hosted. For example, the singular card offers direct access between the DPU 112 and the multiple GPUs 116. This enables a DPU 112 to send different payload of different image sections 106A directly to the different GPUs 116 without the host's intervention other than the host identifying the image sections of interest or identifying a potential defect or a view for at least one of the items, as provided by the image sections. The different GPUs 116 can process their respective image sections 106A based in part on different features of the items or different types of defects.

In one example, the different GPUs 116 may be enabled to perform different image processing on different image sections 106A that may be based in part the different GPUs 116 having therein respective image processing algorithms. The different image processing algorithms may be directed to detecting different features of items, which may be correlated to different views for the items 102B. Therefore, at least one of the different features can be used to determine if a view for at least one of the items, in an image section, is proper or improper. In a similar manner, The different image processing algorithms may be directed to detecting different types of defects of items, which may be corrected to different potential defects for the items 102B. Therefore, at least one of the different types of defects can be used to determine if a potential defect for at least one of the items, in an image section, is confirmed or not confirmed.

In addition, a respective GPU kernel 140 may be associated with each of the different GPUs 116 to support the different image processing to be performed on the image sections 106A. In one example, a GPU kernel 140 may use command scripts to load the payload of a specific image section and to enable a GPU to perform image processing for a specific image section. The GPU kernel 140 can function based in part on its command scripts being executed on one of the GPUs 116 to support a range of host kernels associated with the CPU 118 of a host 108. The GPU kernel 140 can be executed many times and may be executed in parallel by different threads on each of the GPUs 116.

In one example, each thread may be assigned a unique identifier or an index to be used to compute memory addresses and for control decisions. Further, kernel calls associated with a GPU kernel 140 may be executed by different circuits forming multiprocessors cores within each of the GPUs 116. These circuits allow performance of the different threads, in one instance. These different threads may be subject to scheduling and may be used to perform image processing for at least one application 134. The GPUs 116 may enable provision 132 of information from a detection of a defect in at least one item 102B to be displayed or indicated in some form to the application 134. Further, although described as detection of a defect, the application 134 herein may be an interface to provide information, including information associated with the potential defects, based in part on the image processing performed on the image section. The interface may also be used to provide information associated with the value which is based in part on the image processing performed on one or more of the image sections.

In FIG. 1, therefore, the system 100 may include a manufacturing area 102 for items 102B to move through. These items 102B may move through at a predetermined rate. The predetermined rate may be associated with a time synchronization performed between the compute units associated with the CPU 118 and the DPU 112 and the processing node associated with the GPUs 116, as well as with the image sensor 104. Further, the predetermined rate may be so that streaming fusion may be performed for the images captured and to enable the detection of defects for the items to occur expeditiously. For example, the header information 124 to the CPU 118 may be stored in a local access to the CPU 118. However, an application 134 may have predetermined information that is used to indicate image section information 136 to the DPU 112. The provision of the image section information 136 allows the DPU 112 to provide at least an underlying image section, in its payload P form, to one of the GPUs 116. A GPU 116 may, however, indicate an image section it is to receive to the DPU 112, in a different example. Further, such a process may occur concurrently for multiple image sections and for multiple GPUs 116. The image processing in the GPUs 116 are all to be performed in a time that may be limited by the predetermined rate at which the items move through the cameras. Further, one or more memory areas 128, 130, 138 in the system may be also limited and may require the image processing to be performed expeditiously as new images enter the system 100.

In at least one embodiment, the predetermined rate may be also constrained based in part on an ability of the image sensor 104 to capture images associated with the items 102B for the image processing. The DPU 112 can receive the images associated with the sensor data 106 and in the form of the packets Pkt 1-N 126A and can receive an indication of an image section associated with a potential defect or associated with a view for at least one of the items 102B. For example, the items 102B may need to be monitored for certain potential defects or may need to be monitored for certain features. These potential defects and features may be predetermined and may be supported by the specific image processing capabilities imparted to the different GPUs 116. Further, a CPU 118 of a host 108 is able to review header information 124 of the packets Pkt 1-N 126A. An application 134 performed by the CPU 118 may be able to provide image section information 136 to the DPU 112. The image section information 136 may be indicative of only image sections 106A of the different images to be reviewed by the different GPUs 116, whereas the remaining payload of each image represented by the sensor data 106 may be discarded.

In one example, individual ones of the GPUs 116 may be associated with one feature of an item or with a type of defect. The association may be based in part on specific image processing capabilities imparted to a GPU by an image processing algorithm associated with a respective GPU kernel. This enables the GPU to perform the different image processing that is based in part on different features of the items or different types of defects. The DPU 112 may retain a table of associated GPUs 116 and their capabilities. New GPUs may be added to the system 100 based in part on information provided to one or more of the DPU 112 or the CPU 118 to indicate their capabilities. In at least one embodiment, the DPU 112 is able to provide image sections to a specific ones of the GPUs 116 based in part on the GPU's capabilities as to being able to detect variations in a view of an item from the features associated therewith or being able to detect (or confirm) a type of defect from the image section having a potential defect confirmed.

FIG. 2 is an illustration of aspects 200 of individual ones of the different GPUs adapted for different image processing based in part on different features of items under manufacture or different types of defects, in at least one embodiment. FIG. 2 illustrates that provision of the image sections from the DPU 112 to a specific one of the GPUs 116, 208A, 208B may be based in part on an indication received in the DPU 112 of each of the image section being associated with one or more different views 210A, 210B, and 210C for at least one item 102B. For example, the cameras 202 of the image sensor 104 may be co-located at different angles to provide the different views of the images, illustratively marked as reference 204, of the at least one item 102B. These images may correspond to the images represented by the sensor data 106. The DPU 112 may receive complete images, generally referenced as images 204, from these cameras and which may be represented in the sensor data 106.

In one example, images represented by the sensor data 106 may be from multiple cameras C1, C2, and C3 providing different views 210A, 210B, and 210C of the items 102B. The images may be of wider areas around features F1-F3 of the item 102B and are generally referenced by reference numeral 204. The DPU 112 can receive the images 204 but may only provide 206A, 206B, and/or 206C specific payload P associated with specific ones of the features F1, F2, or F3 corresponding to the image sections 106A to specific ones of the GPUs 116. 208A, 208B. This provision from the DPU 112 to specific ones of the GPUs 116, 208A, 208B may be based in part on the individual ones of the GPUs 116, 208A, 208B being associated with individual ones of the features F1-F3 of the items 102B and based in part on the indication received in the DPU 112. Each of the GPUs 116, 208A, 208B may be able to perform a specific image processing according to its capabilities. For example, each one of the GPUs 116, 208A, 208B may be associated with a specific image processing algorithm through a respective GPU kernel 140. For example, image processing may include one or more of pattern recognition, object recognition, feature extraction, feature characterization, or image segmentation.

Further, the different views 210A, 210B, and 210C of the item 102B may be for specific features F1, F2, and F3 that may be known areas of concern for the item 102B. In one example, the specific features F1, F2, and F3 may be corners, surfaces, or other specific areas of the item 102B. In one example, an application 134 performed by a CPU 118 may determine such areas to be potential defect areas for the item 102B, based in part on predetermined information available in the application for each item. In one instance, the header information 124 provided to an application 134 from the DPU 112 may be also used. For example, an application 134 performed by the CPU 118 may have predetermined information of different items that may also include the item 102B at issue. The predetermined information may include potential features that may be areas of concern for each of different types of items and of views required to perform detection of defects for those potential features of the different types of items. Such predetermined information may be user-provided.

Then, when the header information for a packet indicates a specific view (such as, by indication which source camera C1-C3 is involved), the application 134 can provide an indication that may include image section information 136 for underlying image sections 106A for the DPU 112 to consider. The DPU 112 may then lookup a capabilities table indicating associated GPUs 116, 208A, 208B, and their capabilities and can determine an appropriate one of the GPUs to which to provide the underlying image sections 106A. For example, the appropriate one of the GPUs may be able to perform specific image processing as required for corners, surfaces, or other specific areas of the item 102B. Further, the CPU 118 can also perform the application 134 to cause individual ones of the GPUs 116, 208A, 208B to enable passing the image sections between different GPUs for further image processing associated with a different type of defect or with another feature of the item 102B. However, a GPU may pass the image sections independent of the application 134 and further image processing may be associated with a different type of defect or another characteristic of the item.

In one example, the image section information 136 may include indications of more than one view that is in the payload. The DPU 112 may determine multiple GPUs to perform different image processing. The DPU 112 may cause a first one of the GPUs 116, 208A, 208B to perform the image processing, followed by second one the GPUs 116, 208A, 208B to perform different image processing. In addition, the image sections may be provided by the DPU 112 to each of the different GPUs 116, 208A, 208B or, alternatively, may be provided 212 by the individual ones of the GPUs 116, 208A, 208B themselves.

In at least one embodiment, at least one circuit of each of the GPUs 116 can perform encoder functions as part of a video encoder. For example, an output of each of the GPUs 116 may be a compressed or encoded media stream for further use in an application 134 by the host 108 or a different (and remote) host. In at least one embodiment, at least the CPU aspects of the system 100 may be performed in a datacenter. Each of the GPUs 116 may use default video compression parameters to perform the video compression or encoding. For example, in addition to the image processing, each of the GPUs 116 may perform such video compression or encoding one only the image sections 106A to provide a compressed or encoded media stream that may be based in part on one of an H.264® standard, an MPEG2® standard, an AVC® standard, an HEVC® standard, a VP9® standard, an AV1® standard, or a VVC® standard.

In one example, each of the GPUs 116 may be associated with a mode selection module therein to be used to perform inter or intra mode coding. Such a mode selection may be performed using a mode selection module therein. The mode selection may enable selection of parameters that may be associated with available ones of the encoding parameters. The result of such mode selection is to provide specific encoding for at least one of the image sections 106A. The mode selection can also allow determination of how many bits the encoder of the GPU is willing to sacrifice in order to conceal and/or eliminate a distortion that may be relevant to certain parts of the media selection.

As part of the encoding parameters, a Fourier or other related transform may be performed on blocks within every frame to convert data therein to a frequency domain and to allow quantization or discarding of information based on select frequencies. In doing so, transform coefficients at lower frequencies may be less aggressively quantized than those of higher frequency. Separately, motion estimation may be used to capture and encode movements across video frames. While all such options attempt to improve video compression, they may all serve a similar goal to allow an encoder to compress video into smaller bitstreams by eliminating noise, artifacts, allowing at least more intensive motion estimation and exploiting temporal and spatial redundancy. For example, transform and quantization may be provided by a transformation and quantization (T and Q) module of the encoder, as further parameters to influence one or more of the compression or the encoding.

In view of all such benefits, encoders may differ based in part on selections of proper tool(s) to enable aspects thereof to provide economy of bits. For example, the selections of proper tools is in reference to selection of encoding parameters to enable selection of areas (such as provided by macroblocks (MBs)) within frames of each of the image sections 106A that may be subject to the compression or encoding described herein. This and other such approaches that may be defined within the encoder as different modes that may require more or less bits to ensure a desired quality. A Rate Distortion Optimization (RDO) module of the encoder may be associated with a mode selection module therein to address requirements by the use of RDO metrics, such as Sum of Squared Errors (SSE) or Sum of Transformed Differences (SATD) to determine a cost associated with each selection made and to enable a selection based on the cost.

Further RDO metrics allow further mode selection that benefit from evaluation using further quality measures, including VMAF, SSIM, MS-SSIM, or PSNR. Distortion may be determined as a difference from the original image. In at least one embodiment, each of the GPUs 116 support improved selection of at least the quality measures that may be used to perform the video compression for the image sections 106A herein. In one example, to provide the video compression or encoding herein, the encoder can receive transform coefficients or parameters, such as QPs. The RDO module can operate to optimize, for each point or block of an image section of an image, an efficient representation that may include segmentation, prediction modes, motion vectors (MVs), or the QPs.

In at least one embodiment, use of the RDO output is to make a selection of a mode, as provided by the RDO module. Further, an RDO may be limited to a single point for each block in each of the image sections 106A and may be represented by a linear equation of R+λ*D, where λ (lambda) is a multiplier and where an (R, D) pair may be used with the multiplier to minimize a combined R+D value. R may be associated with a bit rate and D may be associated with distortion as it pertains to quality of the media. The RDO allows ranking, for instance, of candidate solutions using the linear equation to select one of the candidate solutions. Therefore, the lambda value may be associated with a range from 1 to a minimized cost for the set of (R, D). R may be measured in bits and D may be a quality unit, such that the equation provides a measure of units of distortion for every bit of a bit rate used in a video compression process.

To achieve a predetermined bit rate of R, a certain value of lambda may be used. Further, selection of encoding parameters that may include R, D, and lambda values allow the RDO to use different quality measures with the image sections 106A. In at least one embodiment, an encoder may be subject to H.264 encoding. The encoder may include modules in hardware or software, such as a prediction module, the T and Q module, and an entropy coding module. There may be further modules, such as an inverse module, a filter module, a motion process module (to support motion estimation and related aspects), and a prior or reference frames module. The video compression or encoding herein may not have effect on a decoding process for a bitstream provided from the encoder. For example, the decoding process may be according to the H.264 decoding or other decoding relevant to the encoding format used to provide the output bitstream from the encoder and, particularly, as to the entropy coding module.

A bitstream of frames, representing only the image sections 106A of images may be compressed or encoded in each of the GPUs 116 and may include different MBs or macroblocks. In at least one embodiment, different sizes of MBs may be supported in the encoder, including but not limited to 8×8, 8×16, 16×8, 4×4, and 16×16. The MBs likely correspond to displayed pixel data obtained at the location of the blocks. The prediction module can generate a prediction MB that can be used to generate residual data reflective of data subject to quantization, as part of the video compression. There may be multiple prediction options associated with a prediction module, including intra prediction that is associated with previously encoded data that is from a current sequence, such as from each of the image sections 106A. Another option associated with a prediction module includes inter prediction that uses encoded data from other previously encoded frames having only the image sections 106A, as reference frames, such as from the prior or reference frames module. These reference frames can appear before or after the current frame, in the display order and may be associated with motion compensation, such as motion process module that uses previously coded frames, such as provided from the prior or reference frames module.

Yet another option associated with a prediction module includes the use of different prediction block sizes that is available to both, the intra prediction and inter prediction options. The use of different prediction block sizes of the MBs can change an accuracy associated with the predictions. A further option associated with a prediction module includes the use of multiple frames during prediction, which is available in the inter prediction option to provide better accuracy in the predictions. A still further option is to skip MB data or residual data so that the encoder itself performs an inference of the MB data based in part on the prediction MB. One or more of such options represent encoding parameters that may be applied to compress the image sections 106A.

In at least one embodiment, intra prediction may be based at least in part on spatial data within at least each of the image sections 106A. MBs generated as part of the intra prediction may be distinct from the MBs of the frame of the image sections 106A. Residual data may be residual MBs generated by a subtraction of the prediction MB, from a current MB. The residual MB can be subject to transformation, quantization, and entropy coding in the provided modules of each of the GPUs 116 depending on a mode selected by a mode selection module and that may be associated with the RDO module to perform the RDO, for instance. Further, in the encoder of each of the GPUs 116, quantized data may be re-scaled and inverse transformed in the inverse module. An output of the inverse module may be filtered and combined with the prediction MB in the prediction module. Motion estimation from the motion process module may be included. The result may be a reconstructed MB or decoded frames that is provided to the prior or reference frames module for further predictions. In at least one embodiment, the use of one or more of inter prediction or intra prediction represent additional encoding parameters that may be applied to compress image sections 106A for further communication or processing in a host 108 or a remote host.

FIG. 3 is an illustration of further aspects 300 of different image processing for items under manufacture or for different types of defects, in at least one embodiment. FIG. 3 illustrates that an application 134 performed by a CPU 118 may provide a DPU 116 with an indication of image sections 106A that are associated with a potential defect for at least one of the items. For example, there may be predetermined potential defects that may be associated with mechanical fixtures, with surfaces, and with edges of the item 102B. The different GPUs 116 can perform different image processing based in part on different types of defects, including scratches, irregularities, uneven surfaces, or mechanical defects, which may represent different types of defects and may require different types of image processing to be detected. Different than the views of the items 102B, which may be processed for generally deviations from a normal or predetermined structure or finish, the potential defect may be specific to known issues. For example, a deviation from a normal or predetermined structure or finish may result in an improper finding versus a proper finding for a feature F1-F3. However, the detection of a scratches, irregularities, uneven surfaces, or mechanical defects is a confirmation of a potential defect and is more specific.

The DPU 112 may provide only image sections 304A; 304B; 304C associated with a potential defect D1-D3 to an individual GPU of the different GPUs 116, 208A, 208B for image processing. The provision of the image sections 304A; 304B; 304C may be based in part on the individual GPUs being associated with a type of defect, such as having specific image processing algorithms to detect scratches 308A, irregularities 308B, uneven surfaces 308C, or mechanical defects 308D. These defects are non-limiting examples. In one example, images represented by the sensor data 106 may be from multiple cameras C1, C2, and C3 providing different potential defects 302A, 302B, and 302C of the item 102B. The images may be of wider areas around potential defects D1-D3 of the item 102B and are generally referenced by reference numeral 306.

The DPU 112 can receive the images 306 but may only provide 310A, 310B, and/or 310C specific payload P associated with specific ones of the potential defects D1, D2, or D3 corresponding to the image sections 304A, 304B, 304C to specific ones of the GPUs 116, 208A, 208B. This provision from the DPU 112 to specific ones of the GPUs 116, 208A, 208B may be based in part on the individual ones of the GPUs 116, 208A, 208B being associated with individual ones of different types of defects 308A-D possible for the item 102B and based in part on the indication received in the DPU 112. Each of the GPUs 116, 208A, 208B may be able to perform a specific image processing according to its capabilities. For example, image processing may include one or more of pattern recognition for the scratches or smudges, object recognition for the mechanical defects, feature extraction for uneven surfaces, feature characterization for one or more of patterns, objects, or other features, or image segmentation that may be also applicable to segment components of a mechanical defect.

Further, the different types of defects 308A-D of the item 102B may be for specific potential defects D1-D3 that may be known defects possible for the item 102B. In one example, an application 134 performed by a CPU 118 may determine such potential defects by areas for the item 102B, based in part on predetermined information provided to it, although header information 124 provided to it from the DPU 112 may be also used. For example, the CPU 118 may have predetermined information of different items that may also include the item 102B at issue. The predetermined information may include different types of defects 308A-D that may be defects of concern for each of different types of items and may be required to perform detection of defects for those different types of defects of the different types of items. Such predetermined information may be user-provided in a similar manner as described with respect to FIG. 2.

Then, when the header information for a packet indicates a specific potential defect (such as, by indication which source camera C1-C3 is involved), an application 134 performed by the CPU 118 can provide an indication that may include image section information 136 for underlying image sections 304A, 304B, 304C for the DPU 112 to consider. The DPU 112 may then lookup a capabilities table indicating associated GPUs 116, 208A, 208B, and their capabilities and can determine appropriate ones of the GPUs to which to provide the underlying image sections 304A; 304B; 304C. For example, the appropriate one of the GPUs may be able to perform specific image processing as required to confirm scratches or smudges, the mechanical defects, the uneven surfaces, and other defects.

Further, the CPU 118 can also perform an application 134 that can cause individual ones of the GPUs 116, 208A, 208B to enable passing the image sections between different GPUs for further image processing associated with a different type of defect or with another feature of the item 102B. In one example, the image section information 136 may include indications of more than one type of defect that is possible in the payload. The DPU 112 may determine multiple GPUs to perform different image processing. The DPU 112 may cause a first one of the GPUs 116, 208A, 208B to perform the image processing, followed by second one the GPUs 116, 208A, 208B to perform different image processing. In addition, the image sections 304A, 304B, 304C may be provided by the DPU 112 to each of the different GPUs 116, 208A, 208B or, alternatively, may be provided 212 by the individual ones of the GPUs 116, 208A, 208B themselves.

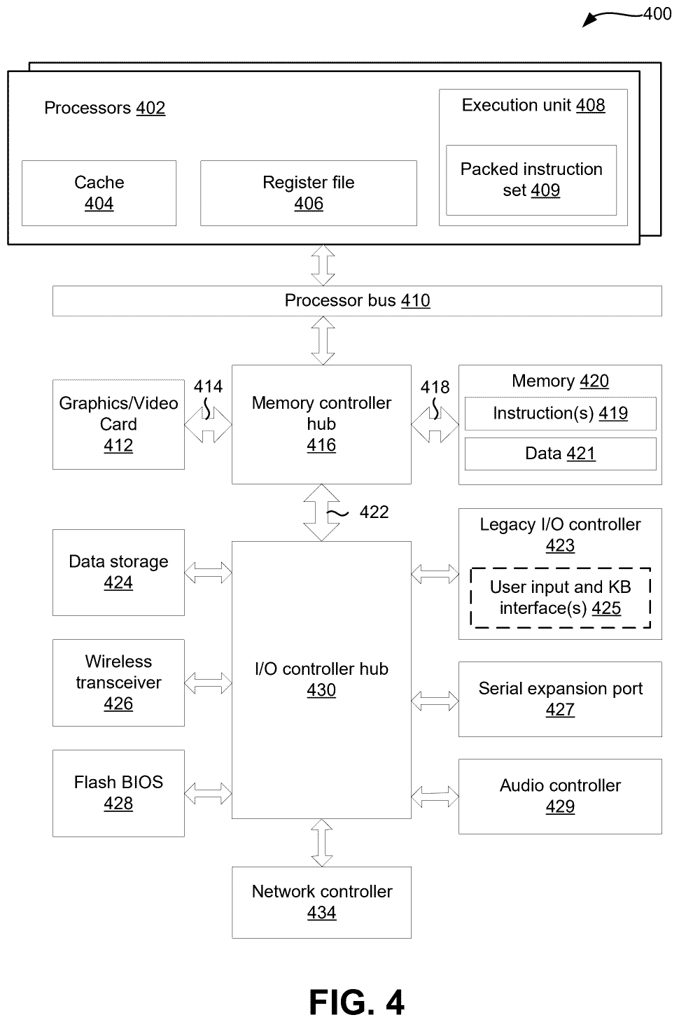

FIG. 4 illustrates computer and processor aspects 400 of a system for manufacturing defect detection using only image sections provided to individual ones of different GPUs adapted for different image processing, in at least one embodiment. For example, each of the illustrated processors 402 may include one or more processing or execution units 408 that can perform any or all of the aspects of the system 100 for manufacturing defect detection using only image sections provided to individual ones of different GPUs adapted for different image processing. Therefore, the processors 402 may be at least a CPU but may include aspects of a GPU and a DPU.

The processing or execution units 408 may include multiple circuits to support the aspects described herein for manufacturing defect detection using only image sections provided to individual ones of different GPUs adapted for different image processing. In at least one embodiment, the processors 402 may include CPUs, GPUs, DPUs that may be associated with a multi-tenant environment to perform one or more aspects of manufacturing defect detection using only image sections provided to individual ones of different GPUs adapted for different image processing. Further, the GPUs may be distinctly in distinct graphics/video cards 412, relative to a DPU (represented by a network controller 434) and a CPU represented by the processors 402 illustrated in FIG. 4. Therefore, even though described in the singular, the graphics/video card 412 may include multiple cards and may include multiple GPUs on each card to be able to receive image sections, where each of the multiple GPUs are adapted for different image processing. This may be also the case with multiple DPUs on a network controller 434. In addition, it is also possible for a card to include DPUs and GPUs thereon to perform aspects herein for manufacturing defect detection using only image sections provided to individual ones of different GPUs adapted for different image processing.

The computer and processor aspects 400 may be performed by one or more processors 402 that include a system-on-a-chip (SOC) or some combination thereof formed with a processor that may include execution units to execute an instruction, according to at least one embodiment. In at least one embodiment, the computer and processor aspects 400 may include, without limitation, a component, such as a processor 402 to employ execution units 408 including logic to perform algorithms for processing data, in accordance with present disclosure, such as in embodiments described herein. In at least one embodiment, the computer and processor aspects 400 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, the computer and processor aspects 400 may execute a version of WINDOWS operating system available from Microsoft Corporation of Redmond, Wash., although other operating systems (UNIX and Linux, for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, or any other system that may perform one or more instructions in accordance with at least one embodiment.

In at least one embodiment, the computer and processor aspects 400 may include, without limitation, a processor 402 that may include, without limitation, one or more execution units 408 to perform aspects according to techniques described with respect to at least one or more of FIGS. 1-3 and 5-7 herein. In at least one embodiment, the computer and processor aspects 400 is a single processor desktop or server system, but in another embodiment, the computer and processor aspects 400 may be a multiprocessor system.

In at least one embodiment, the processor 402 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, a processor 402 may be coupled to a processor bus 410 that may transmit data signals between processors 402 and other components in computer and processor aspects 400.

In at least one embodiment, a processor 402 may include, without limitation, a Level 1 (“L1”) internal cache memory (“cache”) 404. In at least one embodiment, a processor 402 may have a single internal cache or multiple levels of internal cache. In at least one embodiment, cache memory may reside external to a processor 402. Other embodiments may also include a combination of both internal and external caches depending on particular implementation and needs. In at least one embodiment, a register file 406 may store different types of data in various registers including, without limitation, integer registers, floating point registers, status registers, and an instruction pointer register.

In at least one embodiment, an execution unit 408, including, without limitation, logic to perform integer and floating point operations, also resides in a processor 402. In at least one embodiment, a processor 402 may also include a microcode (“ucode”) read only memory (“ROM”) that stores microcode for certain macro instructions. In at least one embodiment, an execution unit 408 may include logic to handle a packed instruction set 409.

In at least one embodiment, by including a packed instruction set 409 in an instruction set of a general-purpose processor, along with associated circuitry to execute instructions, operations used by many multimedia applications may be performed using packed data in a processor 402. In at least one embodiment, many multimedia applications may be accelerated and executed more efficiently by using a full width of a processor's data bus for performing operations on packed data, which may eliminate a need to transfer smaller units of data across that processor's data bus to perform one or more operations one data element at a time.

In at least one embodiment, an execution unit 408 may also be used in microcontrollers, embedded processors, graphics devices, DSPs, and other types of logic circuits. In at least one embodiment, the computer and processor aspects 400 may include, without limitation, a memory 420. In at least one embodiment, a memory 420 may be a Dynamic Random Access Memory (“DRAM”) device, a Static Random Access Memory (“SRAM”) device, a flash memory device, or another memory device. In at least one embodiment, a memory 420 may store instruction(s) 419 and/or data 421 represented by data signals that may be executed by a processor 402.

In at least one embodiment, a system logic chip may be coupled to a processor bus 410 and a memory 420. In at least one embodiment, a system logic chip may include, without limitation, a memory controller hub (“MCH”) 416, and processors 402 may communicate with MCH 416 via processor bus 410. In at least one embodiment, an MCH 416 may provide a high bandwidth memory path 418 to a memory 420 for instruction and data storage and for storage of graphics commands, data, and textures. In at least one embodiment, an MCH 416 may direct data signals between a processor 402, a memory 420, and other components in the computer and processor aspects 400 and to bridge data signals between a processor bus 410, a memory 420, and a system I/O interface 422. In at least one embodiment, a system logic chip may provide a graphics port for coupling to a graphics controller. In at least one embodiment, an MCH 416 may be coupled to a memory 420 through a high bandwidth memory path 418 and a graphics/video card 412 may be coupled to an MCH 416 through an Accelerated Graphics Port (“AGP”) interconnect 414. In at least one embodiment, the graphics/video card 412 may be coupled to one or more of the processors 402 via a PCIe interconnect standard. Similarly, a network controller 424 may also be coupled to one or more of the processors 402 via a PCIe interconnect standard.

In at least one embodiment, the computer and processor aspects 400 may use a system I/O interface 422 as a proprietary hub interface bus to couple an MCH 416 to an I/O controller hub (“ICH”) 430. In at least one embodiment, an ICH 430 may provide direct connections to some I/O devices via a local I/O bus. In at least one embodiment, a local I/O bus may include, without limitation, a high-speed I/O bus for connecting peripherals to a memory 420, a chipset, and processors 402. Examples may include, without limitation, an audio controller 429, a firmware hub (“flash BIOS”) 428, a wireless transceiver 426, a data storage 424, a legacy I/O controller 423 containing user input and keyboard interface(s) 425, a serial expansion port 427, such as a Universal Serial Bus (“USB”) port, and a network controller 434. In at least one embodiment, data storage 424 may comprise a hard disk drive, a floppy disk drive, a CD-ROM device, a flash memory device, or other mass storage device.

In at least one embodiment, FIG. 4 illustrates computer and processor aspects 400, which includes interconnected hardware devices or “chips”, whereas in other embodiments, FIG. 4 may illustrate an exemplary SoC. In at least one embodiment, devices illustrated in FIG. 4 may be interconnected with proprietary interconnects, standardized interconnects (e.g., PCIe) or some combination thereof. In at least one embodiment, one or more components of the computer and processor aspects 400 that are interconnected using compute express link (CXL) interconnects.

Therefore, the at least one execution unit 408 may be a circuit of at least one processor 402 to be associated with a system for manufacturing defect detection using only image sections provided to individual ones of different GPUs adapted for different image processing. The association may be such that the at least one execution unit 408 of at least one processor 402 can perform at least aspects of different GPUs, aspects of a DPU, or aspects of a CPU. The association may be such that the at least one execution unit 408 of at least one processor 402 can load and run or execute instructions to perform such aspects. However, the association may be such that the at least one execution unit 408 of at least one processor 402 may be hardwired to perform such aspects.

Further, at least one execution unit 408 may be a circuit of at least one processor 402 that may be a CPU, DPU, or a GPU, as in FIGS. 1-3, to perform aspects of manufacturing defect detection using only image sections provided to individual ones of different GPUs adapted for different image processing. As such, the computer and processor aspects 400 may include multiple circuits, which may include a DPU associated with a multiple GPUs. The DPU may be able to receive images captured by an image sensor of items moving through a manufacturing area at a predetermined rate. The DPU may be also able to receive an indication of image sections associated with a potential defect or view for at least one of the items. The indication may be received from an application performed by a CPU of a host. Further, the DPU can provide only the image sections to an individual GPUs of the multiple GPUs for image processing. The provision of the image sections may be based in part on the individual GPU being associated with a feature of the one of the items or with a type of defect. Therefore, the individual GPU may be selected from the multiple GPUs where the multiple GPUs are to perform different image processing based in part on different features of the items or different types of defects.

The circuits in FIG. 4 may be such that the image sections are to be passed between different GPU of the multiple GPUs for further image processing associated with a different type of defect or another feature of the one of the items. In one example, an application may cause the DPU to perform this by directly providing a same image section to a second GPU for different image processing after it was previously provided to a first GPU for image processing. An application can also determine a characteristic of the manufacturing process of the item, which may be indicated to a DPU. The different GPUs can then perform the different image processing for further values associated with other characteristics of the manufacturing process of the item, relative to an initial value from at least one characteristic performed by an initial GPU. Further, each of the multiple GPUs may be able to pass along the image section on its own. In one example, it is possible for the multiple GPUs to share a buffer to enable a second one of the multiple GPUs to retrieve and perform different image processing on payload of the image section after a first one of the multiple GPUs has retrieved a copy of the payload for image processing.

The circuits in FIG. 4 may be such that the application of the host or that is associated with a CPU may be able to determine the potential defect from header information associated with the payload or from predetermined information about each item. For example, the DPU may provide with access to the header information for an application performed by a CPU. However, distinct from the header information, the application may indicate that the payload belongs to areas of potential defect or to a view for at least one of the items. The application can provide the indication of the image section for the DPU. This may be based in part on the application having predetermined information about an item, in one example. The application may also cause the individual GPU to pass the image section to a different GPU of the multiple GPUs for further image processing associated with a different type of defect or another feature of the one of the items. However, the GPUs may pass the image sections independent of the application.

In one example, the application may indicate that the payload belongs to multiple areas of potential defects or to multiple views for at least one of the items. Therefore, different image processing may be needed for the payload and this may be performed by successive ones of the different GPUs. The circuits of FIG. 4 may also be such that the image sensor may be time synchronized. The image sensor may be time synchronized so that capturing of the images and processing by the circuits in FIG. 4 may altogether support the image processing within at least a threshold of the predetermined rate established for the movement of the items through the manufacturing arca.

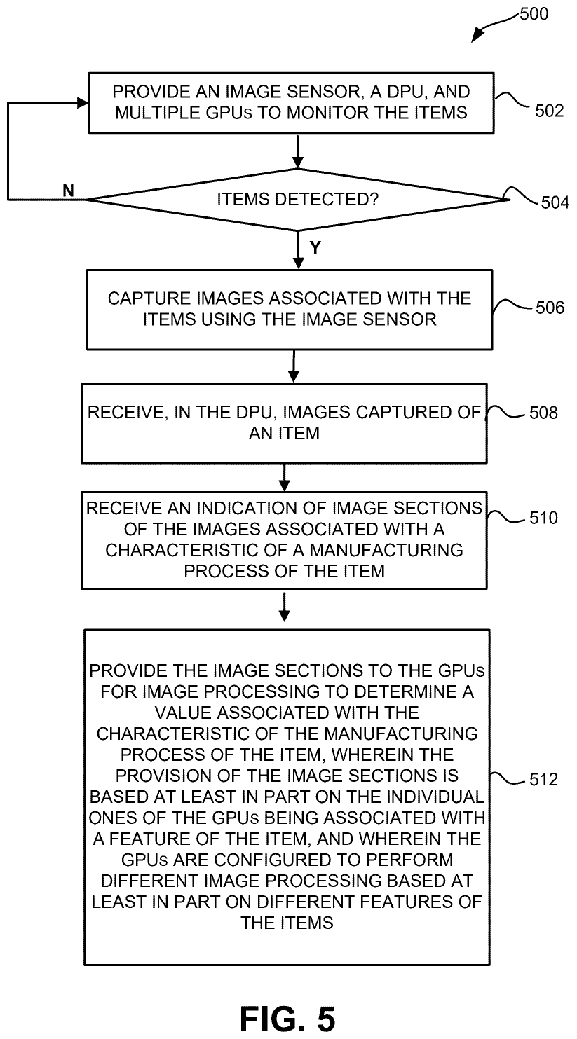

FIG. 5 illustrates a process flow or method 500 for a system for manufacturing defect detection using only image sections provided to individual ones of different GPUs adapted for different image processing, in at least one embodiment. The method 500 may include enabling movement of items through a manufacturing area at a predetermined rate. This may be so that there is no delays or bottlenecks to determining defects that may sometimes be caused by aspects of a manufacturing line and that may result in immediate fixes to the manufacturing line, for instance. In one example, the predetermined rate for the movement through the manufacturing line may be adjustable or may be a threshold difference with respect to a rate at which the detection for defects can occur using the compute and processing nodes herein.

The method 500 may include providing 502 an image sensor, a DPU, and multiple GPUs to monitor the items. A verification or determination 504 may be performed for detecting that the manufacturing line has items moving thereon. The method 500 may include capturing 506 images associated with the items using the image sensor as they move on the manufacturing line. The method 500 may include providing the images to a DPU, along with an indication of image sections associated with a potential defect or view for at least one of the items. The DPU, in turn, can determine the image sections in each of the images and provide the image sections to individual GPUs of the multiple GPUs available to the DPU.

From the perspective of the DPU, the method 500 may include receiving 508, in the DPU, images captured of an item and receiving 510 an indication of image sections of the images associated with a characteristic of a manufacturing process of the item. The method 500 may include providing 512 the image sections to the GPUs for image processing to determine a value associated with the characteristic of the manufacturing process of the item. The provision of the image sections may be based at least in part on the individual ones of the GPUs being associated with a feature of the item. Further, the GPUs are configured to perform different image processing based at least in part on different features of the items.

From the perspective of the GPUs, the method 500 may include performing image processing on the image sections based in part on the individual GPUs being associated with a feature of an item or a type of defect. The image processing of step 512 may be to determine a defect and may be performed with support of the movement of the items occurring at the predetermined rate. Further, the multiple GPUs that include the individual GPUs are to perform different image processing based in part on different features of the items or different types of defects. In one example, the different image processing may include one or more of pattern recognition, object recognition, feature extraction, feature characterization, or image segmentation.

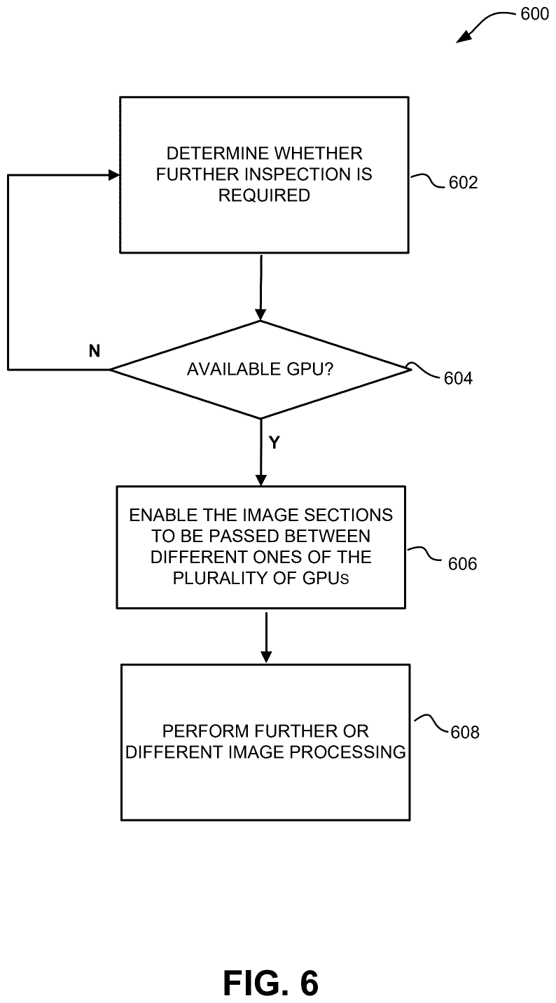

FIG. 6 illustrates yet another process flow or method 600 for a system for manufacturing defect detection using only image sections provided to individual ones of different GPUs adapted for different image processing, in at least one embodiment. The method 600 of FIG. 6 may be used with the method 500 of FIG. 5. In one example, the method 600 may include determining 602 whether further inspection is required for the image section. The method 600 may include determining or verifying 604 that a different GPU to perform further image processing is available. The method 600 may include enabling 606 the image sections to be passed between individual GPUs of the multiple GPUs available to the DPU. The method 600 may include performing 608 further or different image processing. The further image processing may be associated with a different type of defect or another feature of the one of the items. The different image processing may be by virtue of the different GPUs that are configured to perform the different image processing for further values associated with other characteristics of the manufacturing process of the item.

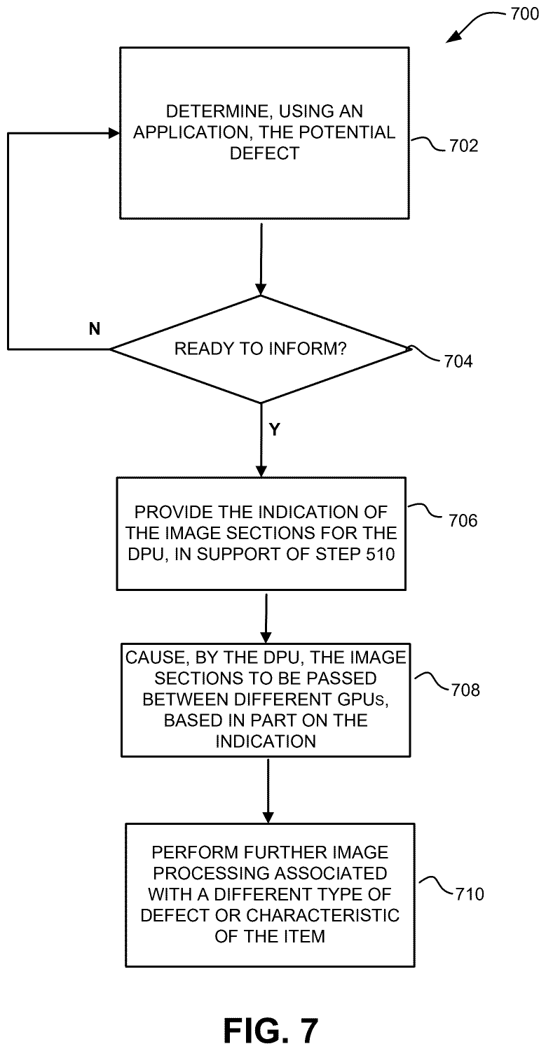

FIG. 7 illustrates a further process flow or method 700 for a system for manufacturing defect detection using only image sections provided to individual ones of different GPUs adapted for different image processing, in at least one embodiment. The method 700 of FIG. 7 may be used with the method 500 of FIG. 5 or the method 600 of FIG. 6. The method 700 may include determining 702, using an application, the potential defect to be addressed in the method 500 of FIG. 5. The method 700 may include verifying or determining 704 that a DPU is ready to receive information about image sections of the images. The method 700 may include providing 706 the indication of the image sections for the DPU. The method 700 may include causing 708, by the DPU, the image sections to be passed between different GPUs of the available GPUs, based in part on the indication in step 510 of FIG. 5. The method 700 may include performing 710 further image processing associated with a different type of defect or another characteristic of the item. The characteristic may be another feature of the one of the items and may be processed by a different GPU, in one example.

In a further example, the indication for a characteristic may be as to a potential defect or view for image sections of at least one of the items may include multiple potential defects or views for at least one of the items. In another example, the indication for the multiple potential defects or views for the image sections of at least one of the items may be received at different times. For example, once a first image processing in a first GPU is complete, a further indication may be received in the DPU to cause a second GPU to perform different image processing for the same image section.

In at least one embodiment, one or more of the methods 500-700 may include a further step or may include a sub-step for providing an interface to communicate information about the value associated with the characteristic of the manufacturing process of the item. The value may be based in part on the image processing performed on one or more of the image sections. The interface may be presented through an application of the host, in one example. The one or more of the methods 500-700 may include a further step or may include a sub-step for the different image processing to be performed on different image sections. The individual ones of the different image sections may be associated with individual GPUs of the available GPUs. The one or more of the methods 500-700 may be such that the image sensor is associated with multiple cameras. The multiple cameras may be in predetermined locations with respect to the items and which have different exposure characteristics. The image sensor can provide the images captured of the item from the predetermined locations. The one or more of the methods 500-700 may be such that the image sensor is time synchronized with one or more of the DPU or the available GPUs to enable capture of the images and to enable the image processing in support of the predetermined rate established for the movement of the items through the manufacturing area.

In at least one embodiment, one or more of the methods 500-700 may include a further step or may include a sub-step for performing, using a central processing unit (CPU), an application to determine the characteristic of the manufacturing process of the item. The methods 500-700 may include a further step or may include a sub-step for providing the indication of the image sections for the DPU. Then, it is possible to cause individual ones of the plurality of GPUs to enable passing the image sections therebetween for further image processing associated with a different type of defect or another characteristic of the item. Further, the methods 500-700 may include performing the different image processing on different ones of the image sections which are associated with different GPUs of the plurality of GPUs.

In the following description, numerous specific details are set forth to provide a more thorough understanding of at least one embodiment. However, it will be apparent to one skilled in the art that the inventive concepts may be practiced without one or more of these specific details.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors.

In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors-for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

Accordingly, in at least one embodiment, computer systems are configured to implement one or more services that singly or collectively perform operations of processes described herein and such computer systems are configured with applicable hardware and/or software that allow performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. References may also be made to providing, outputting, transmitting, sending, or presenting analog or digital data. In at least one embodiment, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A system comprising a manufacturing area for movement of plurality of items therethrough, a data processing unit (DPU), and a plurality of graphics processing units (GPUs), wherein the DPU is to:
receive images captured of an item of the plurality of items;
receive an indication of image sections of the images associated with a characteristic of a manufacturing process of the item; and
provide the image sections to a plurality of GPUs for image processing to determine a value associated with the characteristic of the manufacturing process of the item, wherein the provision of the image sections is based at least in part on the individual ones of the plurality of GPUs being associated with a feature of the item, and wherein the plurality of GPUs are configured to perform different image processing based at least in part on different features of the plurality of items.

2. The system of claim 1, wherein the movement is at a predetermined rate which is in support of the determination of the value associated with the characteristic, and wherein the characteristic of the manufacturing process is a potential defect or view for the item.

3. The system of claim 1, wherein the value associated with the characteristic is based in part on a defect or a type of defect.

4. The system of claim 1, wherein the different image processing comprises one or more of pattern recognition, object recognition, feature extraction, feature characterization, or image segmentation.

5. The system of claim 1, wherein the image sections are to be passed between different GPUs of the plurality of GPUs, wherein the different GPUs are configured to perform the different image processing for further values associated with other characteristics of the manufacturing process of the item.

6. The system of claim 1, further comprising an application which is associated with a central processing unit (CPU), the application to determine the characteristic of the manufacturing process of the item, to provide the indication of the image sections for the DPU, and to cause individual ones of the plurality of GPUs to enable passing the image sections therebetween for further image processing associated with a different type of defect or another characteristic of the item.

7. The system of claim 1, further comprising an interface to provide information associated with the value, based in part on the image processing performed on one or more of the image sections.

8. The system of claim 1, wherein the different image processing is to be performed on different ones of the image sections which are associated with different GPUs of the plurality of GPUs.

9. The system of claim 1, further comprising an image sensor, wherein the image sensor is associated with a plurality of cameras which are in predetermined locations with respect to the plurality of items and which have different exposure characteristics, and wherein the image sensor is to provide the images captured of the item from the predetermined locations.

10. The system of claim 1, further comprising an image sensor, wherein the image sensor is time synchronized with one or more of the DPU or the plurality of GPUs to enable capture of the images and the image processing in support of the predetermined rate established for the movement of the plurality of items through the manufacturing area.

11. A plurality of circuits comprising a data processing unit (DPU) and a plurality of graphics processing units (GPUs), wherein the DPU is to receive images captured of an item of the plurality of items and an indication of image sections of the images associated with a characteristic of a manufacturing process of the item, and the plurality of GPUs is perform image processing to determine a value associated with the characteristic of the manufacturing process of the item, wherein the provision of the image sections is based at least in part on the individual ones of the plurality of GPUs being associated with a feature of the item, and wherein the plurality of GPUs are configured to perform different image processing based at least in part on different features of the plurality of items.

12. The plurality of circuits of claim 11, wherein the image sections are to be passed between different GPUs of the plurality of GPUs to perform the different image processing for further values associated with other characteristics of the manufacturing process of the item.

13. The plurality of circuits of claim 11, further comprising a central processing unit (CPU) to perform an application, the application to determine the characteristic of the manufacturing process of the item, to provide the indication of the image sections for the DPU, and to cause individual ones of the plurality of GPUs to enable passing the image sections therebetween for further image processing associated with a different type of defect or another characteristic of the item.

14. The plurality of circuits of claim 11, wherein the plurality of circuits and an image sensor are time synchronized, wherein the image sensor is to capture the images and the plurality of circuits is to support the image processing within at least a threshold of the predetermined rate established for the movement of the plurality of items through the manufacturing area.

15. A method for image-based manufacturing defects detection, comprising:
receiving, in a data process unit (DPU), images captured of an item of the plurality of items;
receiving, in the DPU, an indication of image sections of the images associated with a characteristic of a manufacturing process of the item; and
providing the image sections from the DPU to a plurality of graphic processing units (GPUs) for image processing to determine a value associated with the characteristic of the manufacturing process of the item, wherein the provision of the image sections is based at least in part on the individual ones of the plurality of GPUs being associated with a feature of the item, and wherein the plurality of GPUs are configured to perform different image processing based at least in part on different features of the plurality of items.

16. The method of claim 15, wherein the different image processing comprises one or more of pattern recognition, object recognition, feature extraction, feature characterization, or image segmentation.

17. The method of claim 15, further comprising:
enabling the image sections to be passed between the individual GPUs of the plurality of GPUs; and
performing, using the individual GPUs, the different image processing for further values associated with other characteristics of the manufacturing process of the item.

18. The method of claim 15, further comprising:
performing, using a central processing unit (CPU), an application to determine the characteristic of the manufacturing process of the item;
providing the indication of the image sections for the DPU; and
causing individual ones of the plurality of GPUs to enable passing the image sections therebetween for further image processing associated with a different type of defect or another characteristic of the item; and
performing the different image processing on different ones of the image sections which are associated with different GPUs of the plurality of GPUs.

19. The method of claim 15, further comprising:
providing an interface to communicate information about the value associated with the characteristic of the manufacturing process of the item, wherein the value based in part on the image processing performed on one or more of the image sections.

20. The method of claim 15, further comprising:
associating an image sensor with a plurality of cameras which are in predetermined locations with respect to the plurality of items and which have different exposure characteristics, wherein the image sensor is to provide the images captured of the item from the predetermined locations.
